(19) United States
(12) Patent Application Publication
(10) Pub. No.: US 2010/0086463 A1
(43) Pub. Date: Apr. 8, 2010

(54) METHOD FOR STRUCTURING SILICON CARBIDE WITH THE AID OF FLUORINE-CONTAINING COMPOUNDS

(76) Inventors: Joachim Rudhard, Leinfelden-Echterdingen (DE); Tino Fuchs, Tuebingen (DE)

Correspondence Address: KENYON & KENYON LLP, ONE BROADWAY, NEW YORK, NY, 10004, US

(21) Appl. No.: 12/560,978

(22) Filed: Sep. 16, 2009

(30) Foreign Application Priority Data
Sep. 29, 2008 (DE) 102008042450.1

(51) Int. Cl. C01B 31/36; B44C 1/22

(52) U.S. Cl. 423/345; 216/41; 216/51

(57) ABSTRACT

A method for etching silicon carbide, a mask being produced on a silicon carbide layer, the unmasked areas of the silicon carbide layer being etched using a fluorine-containing compound, which is selected from the group including interhalogen compounds of fluorine and/or xenon difluoride. The use of chlorine trifluoride, chlorine pentafluoride, and/or xenon difluoride for structuring silicon carbide layers covered with masks containing silicon dioxide and/or silicon oxide carbide; a structured silicon carbide layer obtained by the method, and a microstructured electromechanical component or a microelectronic component including a structured silicon carbide layer obtained by the method.

### FIELD OF THE INVENTION

The present invention relates to a method for etching silicon carbide, a mask being produced on a silicon carbide layer. It furthermore relates to the use of chlorine trifluoride, chlorine pentafluoride, and/or xenon difluoride for structuring silicon carbide layers covered with masks containing silicon dioxide and/or silicon oxide carbide, a structured silicon carbide layer obtained by the method according to the present invention, and a microstructured electromechanical component or a microelectronic component including a structured silicon carbide layer obtained by the method according to the present invention.

### BACKGROUND INFORMATION

Silicon carbide (SiC) is, by its structure and properties, similar to diamond, since silicon and carbon are located in the same main group and adjacent periods of the periodic system and their atomic diameters are of a similar order of magnitude. The advantage of stability due to its kinship with diamond is, however, also a challenge in structuring the SiC material. Nevertheless, the material has been in the focus of new innovative technologies just because of its high heat resistance and chemical resistance.

Different methods are currently available for structuring SiC, which are mostly adapted methods of silicon technology. A physical effect, such as in ion beam structuring or a combined chemical/physical effect such as in some plasma processes (reactive ion etching, RIE) using fluoro-organic compounds is mostly used.

Thus, for example, U.S. Patent Application No. 2006/0102589 describes plasma etching methods including the steps of forming an etching gas plasma and etching an SiC layer on an object, the etching gas containing NF₃, Ar, and He. In the plasma etching method, the object may have an SiOC layer, and the SiC layer is etched selectively with respect to the SiOC layer. The SiOC layer forms an etching mask in this case.

The disadvantage here, however, is that a gas plasma must be generated for etching SiC. This involves a high degree of equipment complexity. Therefore, alternative processes for structuring SiC without gas plasma would be desirable.

### SUMMARY OF THE INVENTION

The present invention therefore provides a method for etching silicon carbide (SiC), a mask being produced on a silicon carbide layer. The method is characterized in that unmasked areas of the silicon carbide layer are etched using a fluorine-containing compound, which is selected from the group including interhalogen compounds of fluorine and/or xenon difluoride.

Etching of SiC using an etching mask may also be referred to as structuring. The SiC layer may be a component of a more complex layer composite, for example, part of a layer stack on a silicon wafer. It may also be obtained, for example, with the aid of plasma-enhanced chemical vapor deposition (PECVD), low-pressure chemical vapor deposition (LPCVD), epitaxial deposition, or sputtering processes. The thickness of the SiC layer may be in the range from ≧10 nm to ≦100 μm.

Basically any material is usable as a mask in which the structures to be transferred may be represented and against which the etching gas is less reactive than against the SiC to be etched. In particular, but not exclusively, oxide and nitride materials are suitable for this purpose. In general, the mask material may be deposited on the entire surface of the SiC layer and then structured with the aid of photolithography by one of the available methods.

Without being elaborated as a theory, it is assumed that the interhalogen compounds of fluorine or xenon difluoride attack both the silicon and the carbon of the SiC layer and convert them into volatile compounds. This is supported by the strength of the newly formed Si—F bonds.

Using the method according to the present invention, etching rates in SiC from ≧1 μm/min to ≦20 μm/min are achieved, depending on the procedure. It is advantageous in the method according to the present invention in particular that it runs free of plasma, i.e., no etching gas plasma needs to be used.

A single reactor, which may only receive a single wafer, or also a batch reactor such as an LPCVD reactor, for example, may be used as equipment for performing the method. The latter provides all necessary conditions regarding temperature and pressure regulation. In addition, in this type of equipment, up to 200 wafers may be structured simultaneously if the gas is appropriately controlled.

In the method according to the present invention, etching may be performed, for example, at a temperature from ≧293 K to ≦1000 K or from ≧300 K to ≦800 K. The pressure in the gas phase during etching may be, for example, in a range from ≧0.001 Torr to ≦760 Torr or from ≧0.01 Torr to ≦500 Torr. By varying pressure, temperature, and etching agent concentration, etching rate and etching isotropy or anisotropy may be adjusted.

In one specific embodiment of the method, the interhalogen compound of fluorine is selected from the group including chlorine trifluoride (ClF₃) and/or chlorine pentafluoride (ClF₅). These gases are sufficiently reactive against SIC. In particular, for ClF₃ it has been established that the etching process takes place spontaneously.

In another specific embodiment of the method, chlorine gas (Cl₂) is also added during etching. This means that the chlorine gas is thus present in the gas phase during etching. In this way, the selectivity of the etching process may be further adjusted. Chlorine gas is advantageously added when the etching gas is a chlorine/fluorine compound such as ClF₃ or ClF₅. Chlorine gas may be present, for example, in a molar ratio from ≧1:100 to ≦1:1, from ≧1:90 to ≦1:20, or from ≧1:50 to ≦1:10.

In another specific embodiment of the method, the fluorine-containing compound is present in the gaseous form and in the gas phase of the reaction space in a concentration from ≧10 wt. % to ≦100 wt. %. This is understood as the weight ratio of the compound to the total quantity of the gases present in the gas phase. In the case where the gas phase is not entirely formed by the fluorine-containing compound, other gases may be, for example, inert gases such as nitrogen or argon, or also the above-described chlorine gas. The proportion of the fluorine-containing compound may also vary in a range from ≧20 wt. % to ≦90 wt. % or from ≧30 wt. % to ≦80 wt. %.

In another specific embodiment of the method, the mask on the silicon carbide layer includes material which is selected from the group including silicon dioxide (SiO₂), silicon oxide carbide (SiOC), silicon nitride (Si₃N₄), silicon oxide nitride (SiON), graphene, metals, metal oxides, and/or photoresists. Photoresists may be used where low process temperatures prevail. Metal and metal oxides may be prepared by chemical vapor deposition, if necessary, with subsequent oxidation, or with the aid of other epitaxial methods.

In one preferred specific embodiment, the mask includes silicon oxide, which is obtained by forming an oxide layer containing silicon dioxide with the aid of tetraoxysilane (TEOS) oxidation, plasma-enhanced chemical vapor deposition (PECVD) oxidation, or with the aid of a low-pressure chemical vapor deposition (LPCVD); this oxide layer is structured with the aid of photolithography, and subsequently the mask is opened in areas where the SiC layer is to be structured. For example, the LPCVD process may be a high-temperature oxidation (HTO) or a low-temperature oxidation (LTO).

In another preferred specific embodiment, the mask includes silicon oxide and/or silicon oxide carbide, which is obtained by the thermal oxidation of the silicon carbide layer, this oxide layer also being structured with the aid of photolithography and subsequently the mask is opened in the areas where the SiC layer is to be structured. Both silicon oxide and silicon oxide carbide may be obtained by the thermal oxidation of the silicon carbide layer.

A further subject matter of the present invention is the use of chlorine trifluoride ClF₃, chlorine pentafluoride ClF₅, and/or xenon difluoride XeF₂ for structuring the SiC layers covered by masks containing SiO₂ and/or SiOC. The advantages of this procedure have been described above.

A further subject matter of the present invention is a structured SiC layer, which has been obtained by a method according to the present invention.

A further subject matter of the present invention is a microstructured electromechanical component or a microelectronic component, including a structured silicon carbide layer obtained by a method according to the present invention. Examples thereof include microelectromechanical systems (MEMS), which may be used as sensors. They may be MEMS inertial sensors, or MEMS sensors for pressure, acceleration, or yaw rate. Microelectronic components may be, for example, field-effect transistors such as MOSFET, MISFET, or ChemFET, in which the silicon carbide layer is contained in a cover layer.

### BRIEF DESCRIPTION OF THE DRAWINGS

FIGS. 1a-1e show the structuring of an SiC layer masked using SiO₂.

FIGS. 2a-2g show the structuring of an SiC layer, which has been masked using a thermal oxide layer grown on SiC.

### DETAILED DESCRIPTION

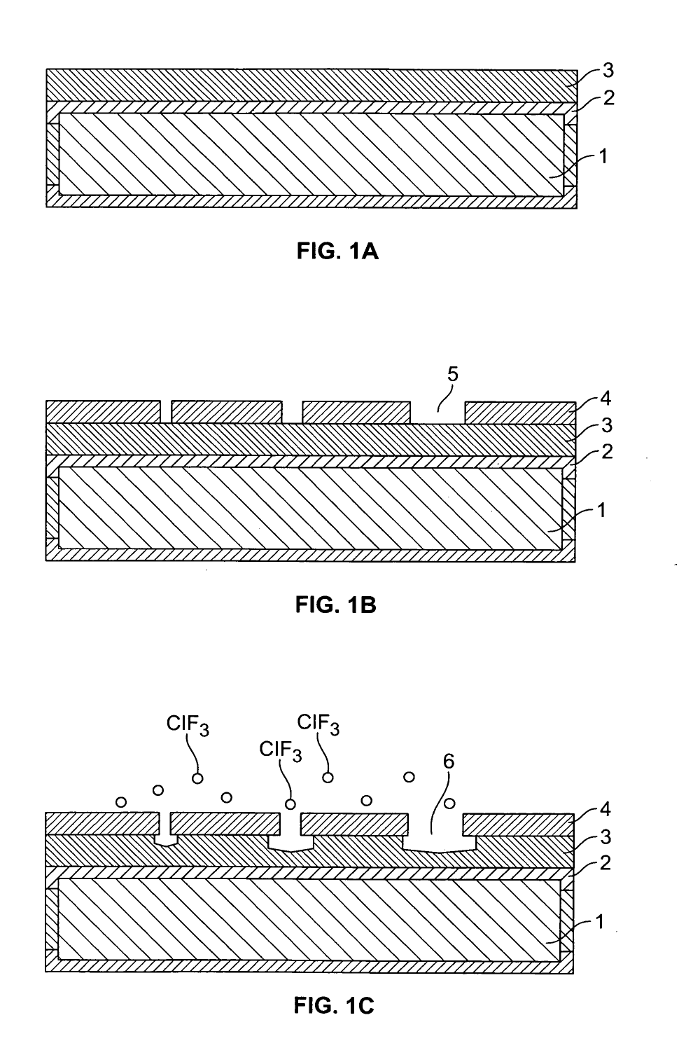

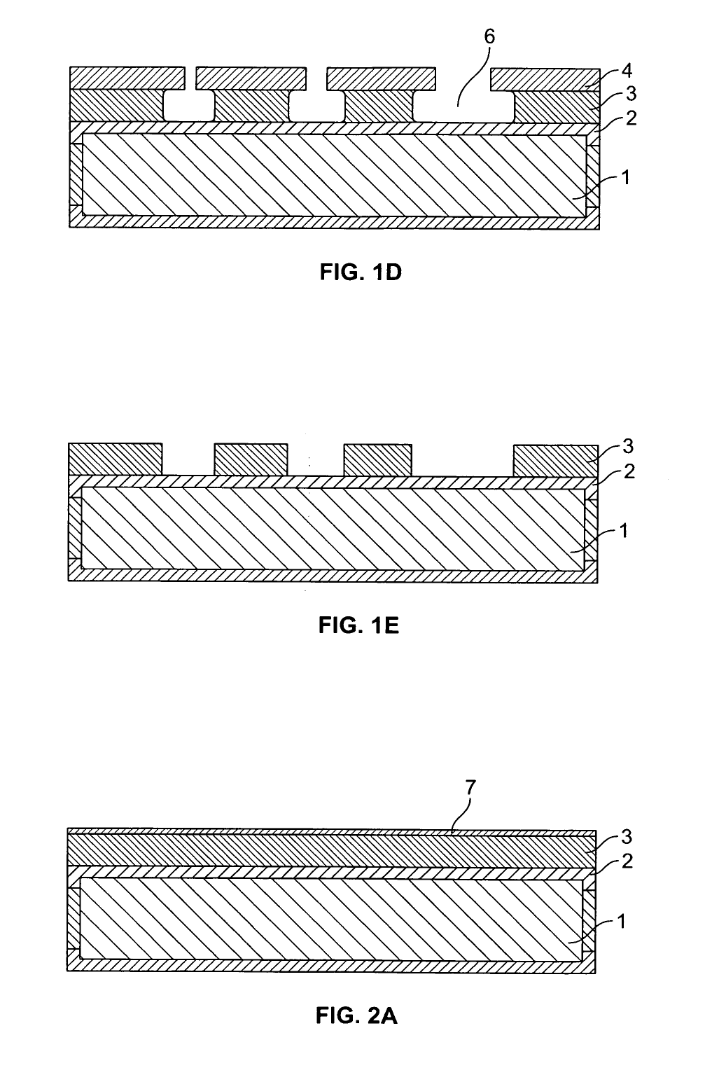

FIG. 1a shows the initial situation for a method according to the present invention. An Si₃N₄-layer 2 is initially situated on a wafer 1 having a layer substructure which is not shown in detail. An SiC layer 3 to be structured is situated on this nitride layer.

FIG. 1b shows the situation after an SiO₂ layer 4 has been deposited on the SiC layer using a PECVD method. Subsequently the structures to be produced are represented on oxide layer 4 with the aid of a photolithography step (not shown). The masking layer and the PECVD oxide are structured with the aid of customary oxide structuring methods. Thus, accesses 5 are created for structuring SiC layer 3.

FIG. 1c shows the etching attack by ClF₃ on SiC layer 3. The etching rate and the isotropy or anisotropy may be adjusted as appropriate via the selection of the process parameters. Here it is shown how etched-out areas 6 get underneath masking layer 4.

In FIG. 1d the etching of SiC layer 3 is completed. FIG. 1e finally shows the finished structured SiC layer after the masking oxide has been removed.

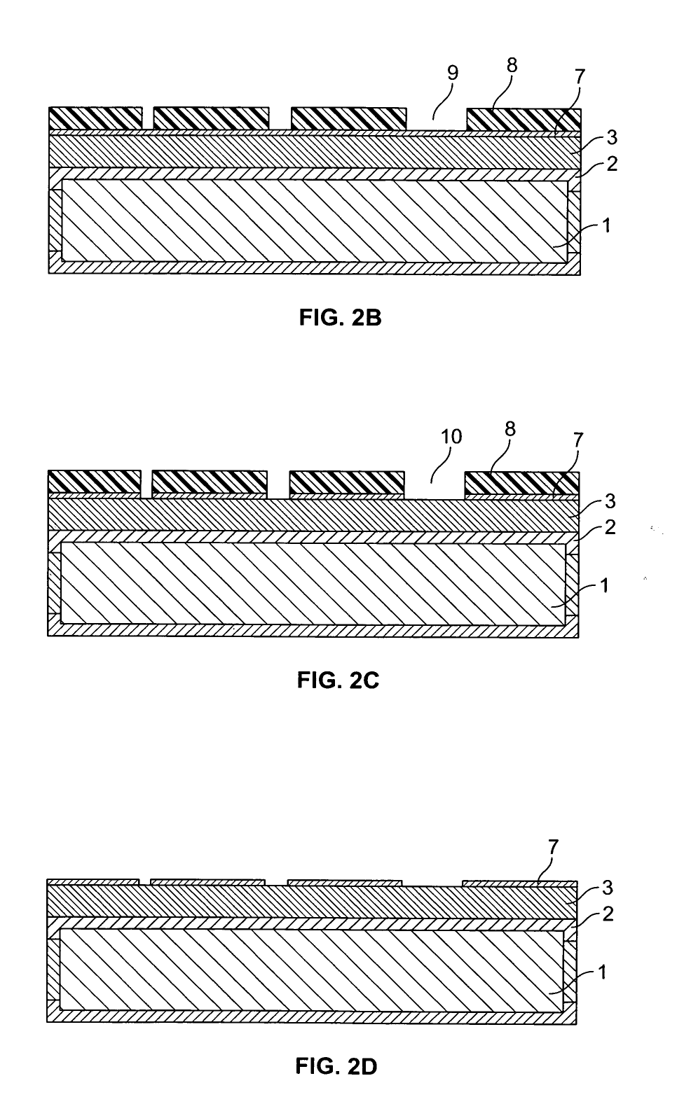

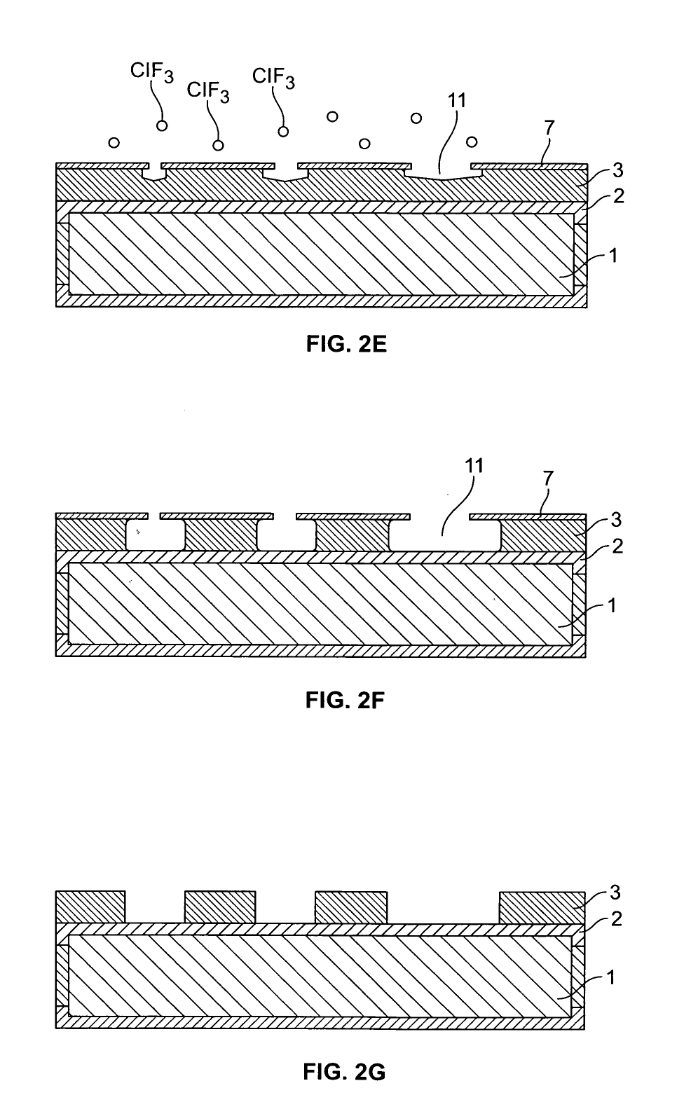

FIG. 2a shows the initial situation for another method according to the present invention. Also in this case, an Si₃N₄-layer 2 is initially situated on a wafer 1 having a layer substructure which is not shown in detail. An SiC layer 3 to be structured is situated on this nitride layer. A layer 7 containing SiOC is produced on SiC layer 3 by thermal oxidation. This oxide layer 7 is used as a mask for the later structuring of SiC layer 3.

FIG. 2b shows how a photoresist 8 has been applied and then the structures to be represented have been produced therein with the aid of a photolithography step. Accesses 9 for the opening of thermally produced oxide layer 7 have thus been produced.

FIG. 2c shows the situation after thermal oxide layer 7 has been opened by an oxide structuring method via accesses 9 and thus accesses 10 for structuring SiC layer 3 have been obtained. All in all, the structures of the photoresist have thus been transferred into oxide layer 7.

In FIG. 2d the photoresist has now been removed. If necessary, a wafer cleaning process may also be performed at this point.

FIG. 2e shows the etching attack by ClF₃ on SiC layer 3. The etching rate and the isotropy or anisotropy may be adjusted as appropriate via the selection of the process parameters. Here it is shown how etched-out areas 11 get underneath oxide mask 7.

In FIG. 2f the etching of SiC layer 3 is completed. FIG. 2g finally shows the finished structured SiC layer after masking oxide 7 has been removed.

What is claimed is:

1. A method for etching silicon carbide, comprising:
producing a mask on a silicon carbide layer; and
etching unmasked areas of the silicon carbide layer using a fluorine-containing compound, which is selected from the group including interhalogen compounds of fluorine and/or xenon difluoride.

2. The method according to claim 1, wherein the interhalogen compound of fluorine is selected from the group including chlorine trifluoride and/or chlorine pentafluoride.

3. The method according to claim 1, wherein chlorine gas is also added during etching.

4. The method according to claim 1, wherein the fluorine-containing compound is present in the gaseous form and in the gas phase of the reaction space in a concentration of ≧10 wt. % to ≦100 wt. %.

5. The method according to claim 1, wherein the mask on the silicon carbide layer includes material which is selected from the group including silicon dioxide, silicon oxide carbide, silicon nitride, silicon oxide nitride, graphene, metals, metal oxides, and/or photoresists.

6. The method according to claim 5, wherein the mask includes silicon dioxide, which is obtained by forming an oxide layer containing silicon dioxide with the aid of tetraoxysilane oxidation, plasma-enhanced chemical vapor deposition oxidation, or with the aid of a low-pressure chemical vapor deposition, the oxide layer being structured with the aid of photolithography, and subsequently the mask is opened in areas where the SiC layer is to be structured.

7. The method according to claim 5, wherein the mask includes silicon oxide and/or silicon oxide carbide, which is obtained by the thermal oxidation of the silicon carbide layer, the oxide layer being structured with the aid of photolithography and subsequently the mask is opened in areas where the SiC layer is to be structured.

8. A structured silicon carbide layer produced by the method of claim 1.

9. A microstructured electromechanical component or a microelectronic component, including a structured silicon carbide layer produced by the method of claim 1.

10. A method comprising:
using chlorine trifluoride, chlorine pentafluoride, and/or xenon difluoride for structuring silicon carbide layers covered by masks containing silicon dioxide and/or silicon oxide carbide.
